(19) United States
(12) Patent Application Publication
(10) Pub. No.: US 2025/0267243 A1
(43) Pub. Date: Aug. 21, 2025

(54) SENSOR BAR FOR 3D NAVIGATION AND RANGE DETECTION

(71) Applicant: Microsoft Technology Licensing, LLC, Redmond, WA (US)

(72) Inventors: Michael BLEYER, Seattle, WA (US); Christopher Douglas EDMONDS, Carnation, WA (US); Christian Markus MAEKELAE, Redmond, WA (US)

(21) Appl. No.: 18/444,242

(22) Filed: Feb. 16, 2024

(51) Int. Cl. H04N 13/25; H04N 13/243; H04N 13/344; H04N 23/11

(52) U.S. Cl. CPC H04N 13/25; H04N 13/243; H04N 23/11; H04N 13/344

(57) ABSTRACT

An HMD is disclosed. The HMD includes a first pair of stereoscopic cameras of a first modality. The first pair of stereoscopic cameras includes a first camera and a second camera. The HMD includes a second pair of stereoscopic cameras of a second modality. The second pair of stereoscopic cameras includes a third camera and a fourth camera. The HMD includes a fifth camera of the first modality and a sixth camera of the second modality. A first separation distance between the first camera and the second camera is set to a user's IPD. A second separation distance between the third camera and the fourth camera is set to the user's IPD. The fifth camera and the sixth camera are positioned on the HMD between the first camera and the second camera and between the third camera and the fourth camera.

### BACKGROUND

Head mounted devices (HMD), or other wearable devices, are becoming highly popular. These types of devices are able to provide a so-called “extended reality” experience.

The phrase “extended reality” (XR) is an umbrella term that collectively describes various different types of immersive platforms. Such immersive platforms include virtual reality (VR) platforms, mixed reality (MR) platforms, and augmented reality (AR) platforms. The XR system provides a “scene” to a user. As used herein, the term “scene” generally refers to any simulated environment (e.g., three-dimensional (3D) or two-dimensional (2D)) that is displayed by an XR system.

For reference, conventional VR systems create completely immersive experiences by restricting their users' views to only virtual environments. This is often achieved through the use of an HMD that completely blocks any view of the real world. Conventional AR systems create an augmented-reality experience by visually presenting virtual objects that are placed in the real world. Conventional MR systems also create an augmented-reality experience by visually presenting virtual objects that are placed in the real world, and those virtual objects are typically able to be interacted with by the user. Furthermore, virtual objects in the context of MR systems can also interact with real world objects. AR and MR platforms can also be implemented using an HMD. XR systems can also be implemented using laptops, handheld devices, and other computing systems.

Unless stated otherwise, the descriptions herein apply equally to all types of XR systems, which include MR systems, VR systems, AR systems, and/or any other similar system capable of displaying virtual content. An XR system can be used to display various different types of information to a user. Some of that information is displayed in the form of a “hologram.” As used herein, the term “hologram” generally refers to image content that is displayed by an XR system. In some instances, the hologram can have the appearance of being a 3D object while in other instances the hologram can have the appearance of being a 2D object.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a head-mounted device (HMD) including: a first pair of stereoscopic cameras of a first modality, the first pair of stereoscopic cameras including a first camera and a second camera; a second pair of stereoscopic cameras of a second modality, the second pair of stereoscopic cameras including a third camera and a fourth camera; a fifth camera of the first modality; and a sixth camera of the second modality, wherein a first separation distance between the first camera and the second camera is set to an interpupillary distance (IPD) of a user of the HMD, and wherein a second separation distance between the third camera and the fourth camera is set to the IPD of the user.

In some aspects, the techniques described herein relate to a system including: a first camera of a first modality; a second camera of the first modality, the first camera and the second camera forming a first stereoscopic pair of cameras; a third camera of a second modality; a fourth camera of the second modality, the third camera and the fourth camera forming a second stereoscopic pair of cameras.

In some aspects, the techniques described herein relate to a system including: a first camera of a first modality; a second camera of the first modality, the first camera and the second camera forming a pair of stereoscopic cameras; a different camera of the first modality; wherein an angular resolution of the different camera is higher than angular resolutions of the pair of stereoscopic cameras, and wherein a first separation distance between the first camera and the second camera is at least initially set to an average interpupillary distance (IPD) of an adult user of the system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example architecture for switching between the use of near field navigation cameras and far field range detection cameras.

FIG. 2 illustrates an example HMD.

FIG. 3 illustrates a sensor bar mounted on an HMD.

FIGS. 4A and 4B illustrate different types or modalities of cameras on the sensor bar.

FIG. 5 illustrates the fields of view of the different cameras.

FIG. 6 illustrates the separation distance between different cameras.

FIG. 7 illustrates the separation distance between different cameras.

FIG. 8 illustrates a flowchart of an example method for switching between near range cameras used for navigation and far range cameras used for range tracking.

FIG. 9 illustrates an example computer system that can be configured to perform any of the disclosed operations.

### DETAILED DESCRIPTION

The disclosed embodiments relate to an improved type of XR system. In particular, the system includes a first stereoscopic camera of a first modality (e.g., perhaps a low light modality) and a second stereoscopic camera of the first modality. The first and second stereoscopic cameras form a first pair of stereoscopic cameras. The system includes a third stereoscopic camera of a second modality (e.g., perhaps a thermal modality) and a fourth stereoscopic camera of the second modality. The third and fourth stereoscopic cameras form a second pair of stereoscopic cameras. The system further includes a fifth camera of the first modality and a sixth camera of the second modality. The fifth camera is positioned on the system between the first camera and the second camera, and the sixth camera is positioned on the system between the third camera and the fourth camera. A first separation distance between the first camera and the second camera is at least initially set to an average interpupillary distance (IPD) of an adult user of the system.

The disclosed embodiments bring about substantial benefits, advantages, and practical applications to the technology by XR systems. In particular, the embodiments improve how enhanced passthrough visualizations are generated and improve the user's experience with the XR system. In particular, the embodiments are able to dynamically (e.g., in real-time) facilitate the switch from using a set of near field “navigation” cameras to using far field “range detection” cameras. Doing so allows the user to become better aware of his/her scene/environment. The embodiments also enable for the merging, fusing, overlaying, or combining of different types of image data into a composite “passthrough” or enhanced image. This passthrough image is an enhanced image because it provides additional information that would not be available if only one of the different types of image data were used. That is, the embodiments provide a synergistic effect by combining multiple different types of data to provide substantial benefits beyond which any one of those data types would be capable of providing.

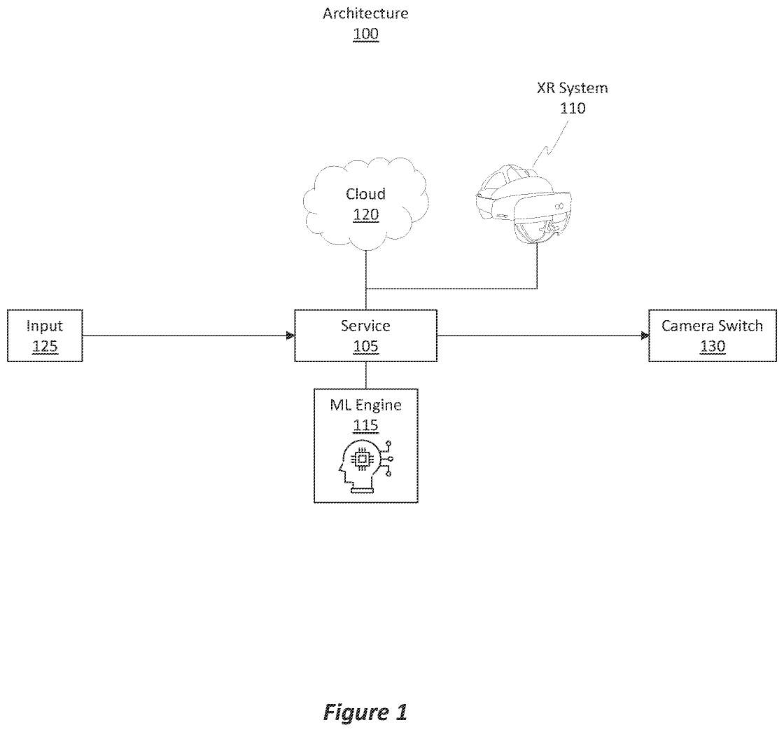

Having just described some of the high level benefits, advantages, and practical applications achieved by the disclosed embodiments, attention will now be directed to FIG. 1, which illustrates an example computing architecture 100 that can be used to achieve those benefits.

Architecture 100 includes a service 105, which can be implemented by an XR system 110 comprising an HMD. As used herein, the phrases XR system, HMD, platform, or wearable device can all be used interchangeably and generally refer to a type of system that displays holographic content (i.e. holograms). In some cases, XR system 110 is of a type that allows a user to see various portions of the real world and that also displays virtualized content in the form of holograms. That ability means XR system 110 is able to provide so-called “passthrough images” to the user. It is typically the case that architecture 100 is implemented on an MR or AR system, though it can also be implemented in a VR system.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 115. The ML engine 115 enables the service to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 120 environment. In some implementations, service 105 is a local service operating on a local device, such as the XR system 110. In some implementations, service 105 is a hybrid service that includes a cloud component operating in the cloud 120 and a local component operating on a local device. These two components can communicate with one another.

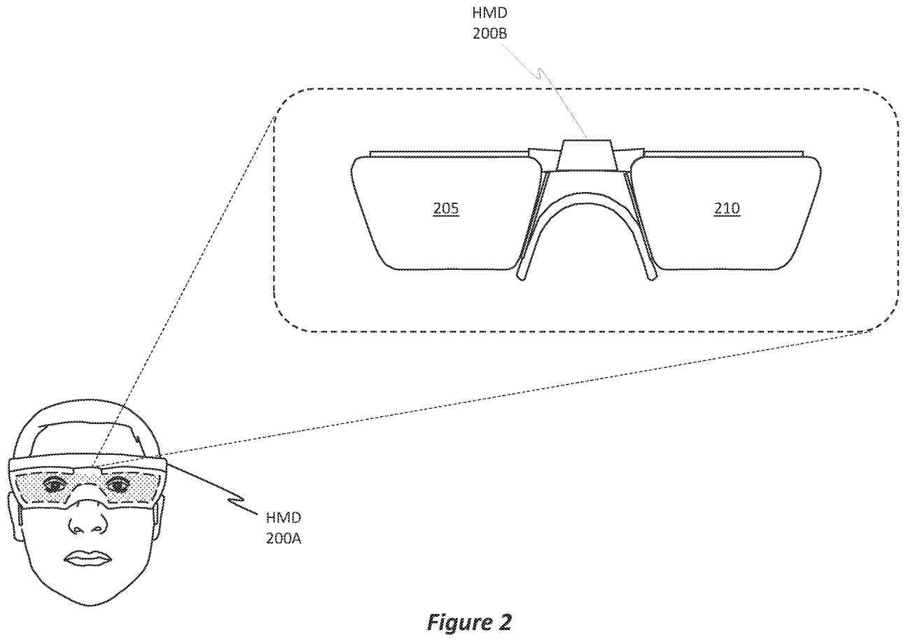

Turning briefly to FIG. 2, HMDs 200A and 200B are shown, where these HMDs are representative of the XR system 110 of FIG. 1. HMD 200B includes a left display 205, and a right display 210. HMD 200B is thus configured to provide binocular vision to the user. That is, HMD 200B displays a first image in the left display 205 and a second, different image in the right display 210. The user will view these two separate images, and the user's mind can fuse them, thereby allowing the user to perceive depth with respect to the holograms.

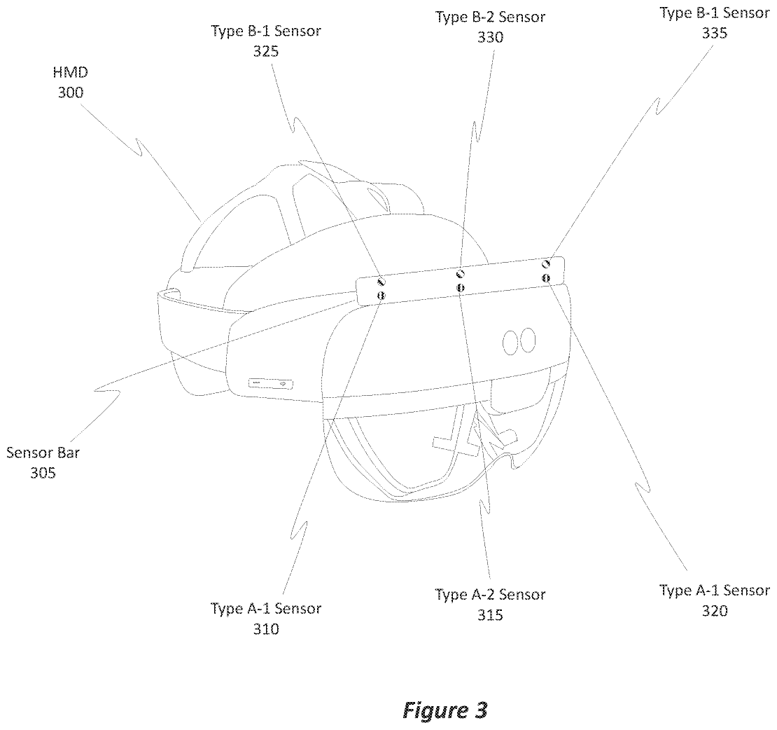

FIG. 3 shows another HMD 300 that is representative of the HMDs discussed thus far. In accordance with the disclosed principles, HMD 300 is equipped with a sensor bar 305. In some embodiments, sensor bar 305 includes a plurality of different types of sensors, or cameras. For instance, FIG. 3 shows how sensor bar 305 includes a type A-1 sensor 310, a type A-2 sensor 315, and a type A-1 sensor 320.

The type A-1 sensors are sensors configured for near field viewing so as to facilitate near field navigation of the user. The type A-2 sensor is a sensor configured for far field viewing so as to detect objects located far from the HMD 300. Further details on these aspects will be provided later.

Sensor bar 305 further includes a type B-1 sensor 325, a type B-2 sensor 330, and a type B-1 sensor 335. Similar to the above description, the type B-1 sensors are sensors configured for near field viewing, and the type B-2 sensor is configured for far field viewing. In some cases, the type A sensors (e.g., A-1 and A-2) are sensors of a first modality, such as one of a red, green, blue (RGB) camera, a low light camera, or a thermal camera. In some cases, the type B sensors (e.g., B-1 and B-2) are sensors of a second modality, such as a different one of an RGB camera, a low light camera, or a thermal camera. In some scenarios, the type A sensors are low light cameras, and the type B sensors are thermal cameras.

Returning to FIG. 1, service 105 is configured to receive user input 125. Service 105 processes the input 125 and switches which cameras are being used by the XR system 110, as shown by camera switch 130. By way of example, suppose the type A-1 sensors from FIG. 3 are initially being used. These sensors facilitate the user in viewing objects that are relatively closer to the user. Now, suppose the user presses a button, activates a switch, or provides any other input indicative of a desire to switch from using the near field cameras to using the far field cameras (e.g., the type A-2 sensor). In response to this input, service 105 switches cameras by deactivating the one or more current cameras being used and by activating one or more new cameras. In some cases, the cameras remain activated, but the content they generate is no longer displayed on the HMD's display. Thus, in some scenarios, the cameras remain on even though their content may not be displayed. In other scenarios, the cameras may be turned off when they are not being used to display content on the HMD's display. Further details are provided below.

By way of additional detail, some XR systems are currently equipped with two low light cameras. These cameras have a fixed focal distance and a fixed field of view (FOV). The fixed focal distance forces users to either focus the lens for near or far distances, which is equivalent to the choice of blurring far or close objects. Similarly, there is a trade-off when modifying the FOV setting because a larger FOV results in a lower angular resolution.

Some XR systems operate using different requirements as they relate to focus and FOV settings. For instance, a first case (referred to herein as the “navigation and situational awareness” case) may require a larger FOV. Because (in this scenario) near objects are more important than far objects (e.g., consider a scenario where the user is walking in a forest), it is desirable to keep near objects in focus and to allow the far objects to be blurry. Furthermore, stereo depth information is particularly relevant when a user interacts or recognizes near objects because depth is particularly relevant when dealing with near objects.

A second use case (referred to herein as the “range detection” case) involves a scenario where the task is to recognize objects that are far away from the XR system. This task often requires a large angular resolution to allow distant objects to be clearly in focus. In contrast to the near distance scenario, stereo information is much less relevant when a user is attempting to look at far objects.

Variable focus lenses can provide a solution that gives the user control over the focal distance. However, this solution has a number of disadvantages, as described below. Variable focus requires user adjustments to the cameras' lenses. Dynamically adjusting a lens is particularly problematic and challenging for less experienced users. As a result, the user experience is often made less enjoyable with variable focus lenses.

Moreover, inconsistencies in focal distances of the left and right cameras often presents a harm to depth perception. Yet another disadvantage is that there are implications on form factor, and additional moving parts will need to be introduced to the XR system. Another issue involves dealing with variable focus lenses in calibration and software, as camera intrinsics are no longer constant. As a result, the use of variable focus lenses is not a desirable solution.

Some XR systems are currently equipped with one thermal camera that is placed in between the left and right low light cameras. This configuration does allow for range detection (i.e. the identification of far objects), but this configuration can hardly be used for navigation (i.e. the near field scenario) because a single camera cannot adequately provide stereo depth information to the user.

In an effort to address the above problems, the disclosed embodiments are directed to a camera system that simultaneously enables navigation (e.g., close range maneuvering) and range detection (e.g., far range maneuvering) for both modalities (i.e. the low light modality as well as the thermal modality). To achieve these benefits, the disclosed systems include at least six cameras, though more may be used.

Three of the six cameras are low light cameras, and the other three are thermal cameras. Out of the three low light cameras, two are used for near range navigation, and the remaining one is used for range detection. Similarly, out of the three thermal cameras, two are used for near range navigation, and the remaining one is used for range detection. The idea of navigation and range detection with three cameras is described in more detail below.

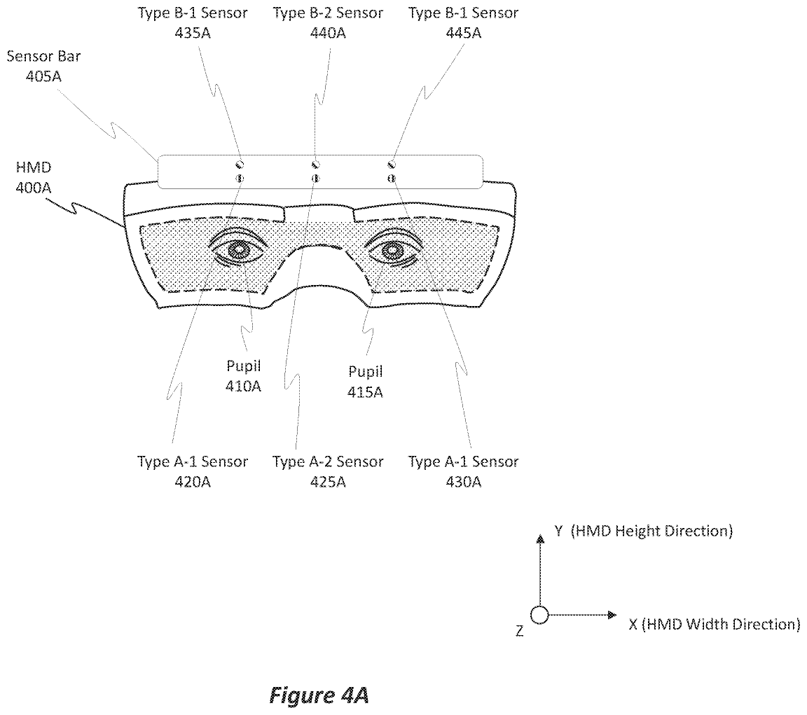

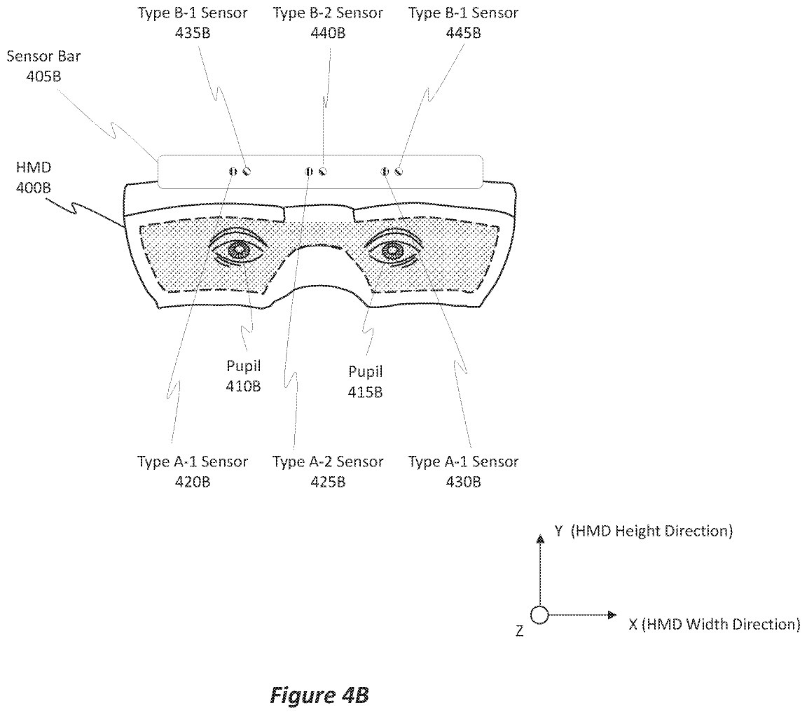

FIGS. 4A and 4B show two possible designs for the disclosed sensor bar, which houses the six different cameras. For both designs, the sensor bar can be placed above the user's eyes on the HMD. This configuration makes sense if the goal is to build an AR system. For VR systems, a better design is to place the sensor bar right in front of the user's eyes on the HMD to minimize vertical parallax effects.

FIG. 4A shows a design that minimizes horizontal parallax. In particular, FIG. 4A shows an HMD 400A that includes a sensor bar 405A, which is representative of the sensor bar 305 from FIG. 3. FIG. 4A also shows the user's pupils, as shown by pupil 410A and pupil 415A.

Sensor bar 405A includes three type A sensors, as shown by type A-1 sensor 420A, type A-2 sensor 425A, and type A-1 sensor 430A. The type A-1 sensors are used for near field navigations while the type A-2 sensor is used for long range object detection.

Sensor bar 405A further includes three type B sensors, as shown by type B-1 sensor 435A, type B-2 sensor 440A, and type B-1 sensor 445A. The type B-1 sensors are used for near field navigations while the type B-2 sensor is used for long range object detection.

The embodiments structure the sensor bar 405A so that the navigation (i.e. near) cameras (e.g., type A-1 sensors and type B-1 sensors) are right above the user's eyes. Notably, the low light sensors (e.g., the type A sensors) are more proximate to the user's pupils than the thermal sensors (e.g., the type B sensors).

While there is no horizontal parallax with this configuration, the disadvantage of this design is that there is relatively high vertical parallax for the thermal cameras. Thus, if there is a higher emphasis on use of the thermal cameras relative to the low light cameras, then the sensor positions can be switched. Notably, the baseline between the navigation cameras corresponds to the average human interpupillary distance (IPD), as otherwise 3D vision may be impacted (i.e. objects would appear too close or too far). For symmetry, the embodiments also place the far low light (e.g., the type A-2 sensor) and the far thermal camera (e.g., the type B-2 sensor) on top of each other in the middle between the other four cameras. A different, perhaps better, form factor can be achieved by placing them next to each other in the same row as opposed to the same column.

FIG. 4B shows an alternative design that leads to a different, perhaps better, form factor and that avoids high vertical parallax for the thermal cameras. This configuration is at the cost of introducing some horizontal parallax to both the type A and type B cameras.

In particular, FIG. 4B shows an HMD 400B that includes a sensor bar 405B, which is representative of the sensor bar 305 from FIG. 3. FIG. 4B also shows the user's pupils, as shown by pupil 410B and pupil 415B.

Sensor bar 405B includes three type A sensors, as shown by type A-1 sensor 420B, type A-2 sensor 425B, and type A-1 sensor 430B. Sensor bar 405B further includes three type B sensors, as shown by type B-1 sensor 435B, type B-2 sensor 440B, and type B-1 sensor 445B.

In FIG. 4B, the embodiments introduce a small horizontal parallax for the low light cameras (e.g., the type A sensors, particularly the type A-1 sensors) as well as the thermal navigation cameras (e.g., the type B sensors, particularly the type B-1 sensors). If the user puts more emphasis on the use of low light cameras, the structure can be altered so that the low light cameras are placed right above the user's eyes to eliminate horizontal parallax. This configuration comes at the cost of higher horizontal parallax for the thermal cameras. Similar to FIG. 4A, it is worthwhile to note that the baseline between navigation cameras matches the average human IPD to avoid problems in 3D depth perception.

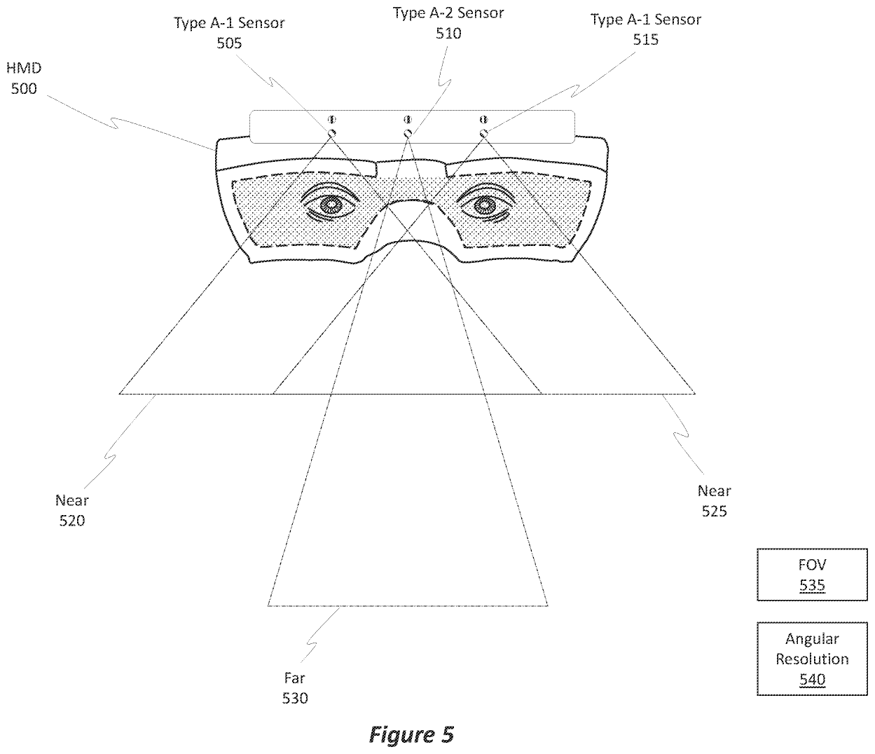

FIG. 5 shows an HMD 500 structured to have a combined navigation and range detection configuration with three cameras, such as type A-1 sensor 505, type A-2 sensor 510, and type A-1 sensor 515. Thermal cameras are also shown by not labeled. The disclosed system uses two cameras for large field of view stereo navigation (i.e. short range navigation), as shown by the type A-1 sensors 505 and 515. Type A-1 sensor 505 has a large field of view for near field navigation, as shown by near 520. Similarly, type A-1 sensor 515 has a large field of view for near field navigation, as shown by near 525.

FIG. 5 also shows one camera for small field of view range detection (i.e. long distance object detection), as shown by type A-2 sensor 510. In particular, type A-2 sensor 510 has a narrow field of view with a large angular resolution to allow for viewing objects at a far distance, as shown by far 530. FIG. 5 illustrates these concepts, as shown by FOV 535 and angular resolution 540.

The disclosed embodiments are able to handle both short range navigation and long range detection with three cameras using only fixed focus and fixed FOV cameras. The navigation (aka situational awareness) use case is covered by the two A-1 sensors 505 and 515 of FIG. 5. The embodiments utilize two cameras in this scenario because stereo depth information is relevant for a user in the near range. The type A-1 cameras have a large FOV, thereby enabling the user to see objects in the peripheral vision. The focal distance of the two A-1 cameras is set to near, thereby causing close objects to appear with a sharp contrast.

The second use case (i.e. range detection) is covered by the center camera shown as the type A-2 sensor 510 in FIG. 5. Note, there is only one camera for covering the long distance scenario because stereo disparity converges to 0 when the distance is increased, or rather, when the distance exceeds a threshold distance (e.g., about 5 meters from the XR system). In other words, for far objects, a second long distance camera would not significantly enhance the user's depth perception. Some embodiments choose a smaller FOV for the long-range camera because the smaller FOV allows the XR system to have an increased angular resolution, which is beneficial to crisply identify objects that are located at a far distance. The focal distance of the type A-2 camera is set to infinity, which ensures that far objects are in focus. Similar principles apply to the type B-1 and type B-2 cameras, respectively. In some scenarios, the size of the FOV of the near cameras is 1.5×, 1.75×, 2.0×, or more than 2.0× the size of the FOV of the far cameras. In some scenarios, the angular resolution of the far cameras is 1.5×, 1.75×, 2.0×, or more than 2.0× the angular resolution of the near cameras.

There are multiple ways to present the camera images to the user via the XR system's display. One technique is to initially display the two stereo cameras (i.e. the type A-1 sensors) that cover the near range to the user. When the user is interested in detecting objects in the distance, the user can, for example, press a button (e.g., the input 125 from FIG. 1). This action will then lead to the long range camera (e.g., the type A-2 sensor) content being displayed to the user. Pressing the button will again switch which cameras are being used.

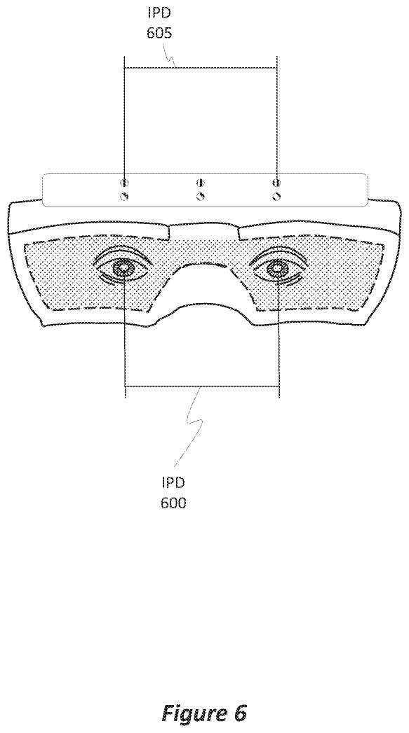

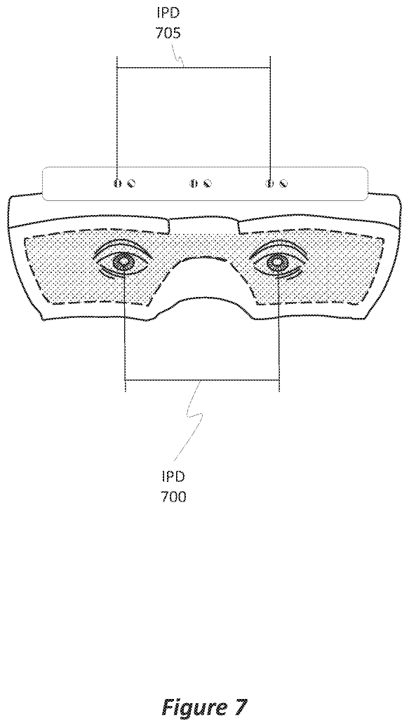

FIG. 6 shows a scenario that illustrates the user's IPD 600. Notice, the distance between the stereoscopic cameras (e.g., the two type A-1 cameras or the two type B-1 cameras) is also set to the same IPD 605. To be clear, IPD 605 is the same distance as IPD 600. In this example scenario, the two sets of stereoscopic cameras are also positioned above the user's pupils so as to reduce or eliminate horizontal parallax. In some cases, the IPD 600 is the user's actual IPD as measured by eye trackers or as otherwise determined by some other technique. In some cases, the IPD 600 is an estimated or average IPD of a human having certain characteristics (e.g., adult male, adult female, youth male, youth female, etc.).

Whereas FIG. 6 showed the sensors in a vertically stacked position on the sensor bar, FIG. 7 shows the sensors in a single row formation on the sensor bar. FIG. 7 also shows the user's IPD 700. Despite the sensors all being on the same row, the distance between the sensors is still set to the same IPD 705. That is, IPD 705 is set to be the same distance as IPD 700.

In some embodiments, the far field cameras (i.e. the type A-2 or type B-2 cameras) are in the middle of the sensor bar and are set to be in a position that is equal distance from either of the two stereoscopic cameras. That is, the type A-2 or B-2 cameras are in the middle between the A-1 or B-1 cameras. In other embodiments, the A-2 or B-2 cameras may be closer to either one of the stereoscopic cameras. For instance, the A-2 or B-2 cameras may be closer to the lefthand A-1 or B-1 cameras; alternatively, the A-2 or B-2 cameras may be closer to the righthand A-1 or B-1 cameras.

Accordingly, some embodiments are directed to a type of head-mounted device (HMD). This HMD may include a first pair of stereoscopic cameras of a first modality. The first pair of stereoscopic cameras comprises a first camera and a second camera. Optionally, the first modality may be a low light modality.

The HMD may further include a second pair of stereoscopic cameras of a second modality. The second pair of stereoscopic cameras comprises a third camera and a fourth camera. Optionally, the second modality may be a thermal modality.

The HMD includes a fifth camera of the first modality and a sixth camera of the second modality. A first separation distance between the first camera and the second camera is set to an interpupillary distance (IPD) of a user of the HMD, and a second separation distance between the third camera and the fourth camera is set to the IPD of the user. In some cases, the cameras are movable at least in a horizontal direction on the sensor bar, such as perhaps via use of a movement mechanism. In some cases, the lefthand cameras and the righthand cameras are independently moveable. In some cases, the separation distance between the lefthand and righthand cameras is controllable so as to set the separation distance to the user's IPD. In some cases, a virtual movement can occur, such as a scenario where the separation distance is programmatically set via reprojection techniques and the actual cameras themselves are not physically moved. In any event, the separation distance between the cameras can either be physically set or virtually set.

Optionally, the fifth camera and the sixth camera are positioned on the HMD between the first camera and the second camera and between the third camera and the fourth camera. In some cases, the fifth camera is positioned an equal distance between the first camera and the second camera. Similarly, in some cases, the sixth camera is positioned an equal distance between the third camera and the fourth camera.

In some implementations, the first and second cameras each has a larger field of view (FOV) relative to a FOV of the fifth camera. Relatedly, an angular resolution of the fifth camera may be larger relative to angular resolutions of the first and second cameras.

The first pair of stereoscopic cameras are configured for relatively near field navigation while the fifth camera is configured for relatively far field navigation. Optionally, the FOV of the first camera is approximately as large as a FOV of the second camera, and the FOVs of the first and second cameras are larger than a FOV of the fifth camera.

In some implementations, the first camera is disposed on a sensor bar of the HMD, and the second camera is disposed on the sensor bar. The first camera is disposed at a first position on the sensor bar with the first position being above a first eye of a user of the HMD. Similarly, the second camera is disposed at a second position on the sensor bar with the second position being above a second eye of the user. In some cases, the first camera, the second camera, and the fifth camera are disposed in a first single row on a sensor bar of the HMD. The third camera, the fourth camera, and the sixth camera may be disposed in a second single row on the sensor bar of the HMD. Alternatively, the first camera, the second camera, the third camera, the fourth camera, the fifth camera, and the sixth camera are all disposed in a same single row on a sensor bar of the HMD.

In some implementations, the HMD includes a movable sensor bar. Specifically, the moveable bar is structured in a manner so that the sensor bar can be moved right in front of the user's eyes. This will block the user's view of the real world, but in some scenarios that is acceptable.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

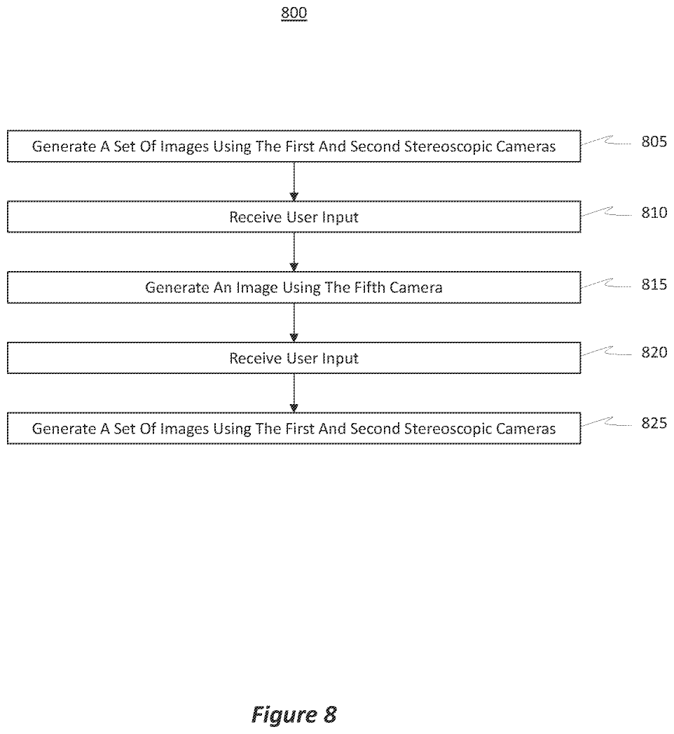

Attention will now be directed to FIG. 8, which illustrates a flowchart of an example method 800 for switching between the use of different cameras mounted on a sensor bar of an HMD. Method 800 can be implemented within the architecture 100 of FIG. 1; further, method 800 can be implemented by the service 105 of FIG. 1.

For instance, if service 105 is implemented by a system (e.g., the XR system 110 of FIG. 1), then this system may include a first stereoscopic camera of a first modality and a second stereoscopic camera of the first modality. The first stereoscopic camera and the second stereoscopic camera form a first pair of stereoscopic cameras.

The system includes a third stereoscopic camera of a second modality and a fourth stereoscopic camera of the second modality. The third stereoscopic camera and the fourth stereoscopic camera form a second pair of stereoscopic cameras.

The system includes a fifth camera of the first modality and a sixth camera of the second modality. Optionally, the fifth camera is positioned on the system between the first camera and the second camera, and the sixth camera is positioned on the system between the third camera and the fourth camera.

In some cases, a first separation distance between the first camera and the second camera is at least initially set to an average interpupillary distance (IPD) of an adult user of the system. Optionally, that first separation distance can later be modified to correspond to a current user's actual IPD. Similarly, a second separation distance between the third camera and the fourth camera is at least initially set to the average IPD of the adult user of the system. This second separation distance can also later be modified to be the current user's actual IPD.

The first modality may be a low light modality, and the second modality may be a thermal modality.

Optionally, the first stereoscopic camera, the second stereoscopic camera, the third stereoscopic camera, and the fourth stereoscopic camera are configured for relatively near field navigation. Optionally, the fifth camera and the sixth camera are configured for relatively far field navigation.

In some cases, the first stereoscopic camera, the second stereoscopic camera, the third stereoscopic camera, and the fourth stereoscopic camera have fields of view (FOVs) that are relatively larger than FOVs of the fifth camera and the sixth camera. Relatedly, the first stereoscopic camera, the second stereoscopic camera, the third stereoscopic camera, and the fourth stereoscopic camera have angular resolutions that are relatively smaller than angular resolutions of the fifth camera and the sixth camera.

Method 800 includes an act (act 805) of generating a set of images using the first and second stereoscopic cameras. If the first and second stereoscopic cameras are low light cameras, then the first set of images are low light images. The first and second stereoscopic cameras are ones that are used to assist the user in near field navigation, such as by detecting objects in the scene or environment that are less than about 5 meters away from the system. In some cases, the distance is less than 4 meters or perhaps less than 3 meters. This set of images can be used to accurately determine the depth of near objects using stereoscopic pixel matching techniques.

In some cases, the third and fourth stereoscopic cameras are simultaneously generating images. If the third and fourth stereoscopic cameras are thermal cameras, then those cameras generate thermal images. The embodiments are able to align the thermal images with the low light images. The embodiments may then selectively extract content from the thermal images and overlay that content onto corresponding content in the low light images, thereby producing an enhanced image that includes both low light content and thermal content.

In some cases, the thermal content can be used to better identify and segment certain objects in the scene, and the thermal content can be used to generate a highlighted or emphasized border around those objects in the resulting enhanced image. That is, the thermal image may be used to generate a border around an object, and the enhanced image may include low light content and the border that was generated using the thermal image. In other embodiments, an entirety of the object in the enhanced image may be overlaid using thermal content.

Method 800 then includes an act (act 810) of receiving user input. This user input may be of any type. For instance, the user input may include the user pressing a button (e.g., a physical button or a holographic button). The user input may include audio input in which the user speaks a phrase. The user input may include a predefined motion performed by the user, where this predefined motion is picked up and recognized using the system's various cameras. Regardless of the type of user input that is received, the user input triggers the system to switch from using the first pair of stereoscopic cameras to now using the fifth camera, which is of the same modality as the first pair of stereoscopic cameras. Optionally, the sixth camera may also be triggered for use.

Act 815 includes generating an image using the fifth camera. The fifth camera is configured for far field navigation, range detection, and recognition. Thus, the images generated by the fifth camera are beneficially usable to detect objects in the scene or environment that are relatively far away from the system. For instance, the images generated by the fifth camera can be used to detect objects that are at least 3 meters away from the system. In some cases, that distance is farther, such as at least 4 meters or at least 5 meters away from the system. Thus, the fifth camera is usable to detect far objects (e.g., at least 3, 4, 5, or more meters away) relative to the system.

Optionally, the sixth camera may simultaneously generate images. If the sixth camera is a thermal camera, then the thermal content from the resulting thermal image can be aligned, selectively extracted, and then overlaid onto corresponding content in the image generated by the fifth camera, thereby producing an enhanced image.

The user may operate in this far field navigation state for a period of time. Subsequently, act 820 includes receiving additional user input.

In response to the user input, act 825 involves switching from using the fifth camera (and potentially the sixth camera) to again using the first pair of stereoscopic cameras (and potentially the second pair of stereoscopic cameras). Accordingly, the user can switch back and forth between the near field navigation cameras and the far field range detection cameras.

### Example Computer/Computer Systems

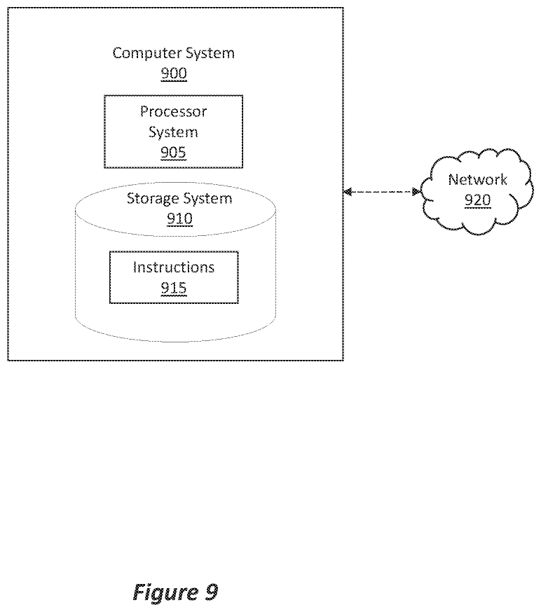

Attention will now be directed to FIG. 9 which illustrates an example computer system 900 that may include and/or be used to perform any of the operations described herein. For instance, computer system 900 can be in the form of the XR system 110 of FIG. 1 and can implement the service 105.

Computer system 900 may take various different forms. For example, computer system 900 may be embodied as a tablet, a desktop, a laptop, a mobile device, or a standalone device, such as those described throughout this disclosure. Computer system 900 may also be a distributed system that includes one or more connected computing components/devices that are in communication with computer system 900.

In its most basic configuration, computer system 900 includes various different components. FIG. 9 shows that computer system 900 includes a processor system 905 that includes one or more processor(s) (aka a “hardware processing unit”) and a storage system 910.

Regarding the processor(s) of the processor system 905, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 900. The different components, modules, engines, and services described herein may be implemented as objects or processors that execute on computer system 900 (e.g. as separate threads).

Storage system 910 may be physical system memory, which may be volatile, non-volatile, or some combination of the two. The term “memory” may also be used herein to refer to non-volatile mass storage such as physical storage media. If computer system 900 is distributed, the processing, memory, and/or storage capability may be distributed as well.

Storage system 910 is shown as including executable instructions 915. The executable instructions 915 represent instructions that are executable by the processor(s) the processor system 905 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 900 may also be connected (via a wired or wireless connection) to external sensors (e.g., one or more remote cameras) or devices via a network 920. For example, computer system 900 can communicate with any number devices or cloud services to obtain or process data. In some cases, network 920 may itself be a cloud network. Furthermore, computer system 900 may also be connected through one or more wired or wireless networks to remote/separate computer systems(s) that are configured to perform any of the processing described with regard to computer system 900.

A “network,” like network 920, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 900 will include one or more communication channels that are used to communicate with the network 920. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A head-mounted device (HMD) comprising:
a first pair of stereoscopic cameras of a first modality, the first pair of stereoscopic cameras comprising a first camera and a second camera;
a second pair of stereoscopic cameras of a second modality, the second pair of stereoscopic cameras comprising a third camera and a fourth camera;
a fifth camera of the first modality; and
a sixth camera of the second modality,
wherein a first separation distance between the first camera and the second camera is set to an interpupillary distance (IPD) of a user of the HMD, and
wherein a second separation distance between the third camera and the fourth camera is set to the IPD of the user.

2. The HMD of claim 1, wherein the fifth camera and the sixth camera are positioned on the HMD between the first camera and the second camera and between the third camera and the fourth camera.

3. The HMD of claim 1, wherein the first modality is a low light modality, and wherein the second modality is a thermal modality.

4. The HMD of claim 1, wherein the first and second cameras each has a larger field of view (FOV) relative to a FOV of the fifth camera.

5. The HMD of claim 1, wherein an angular resolution of the fifth camera is larger relative to angular resolutions of the first and second cameras.

6. The HMD of claim 1, wherein the first pair of stereoscopic cameras is configured for relatively near field navigation while the fifth camera is configured for relatively far field navigation.

7. The HMD of claim 1, wherein a field of view (FOV) of the first camera is approximately as large as a FOV of the second camera, and wherein the FOVs of the first and second cameras are larger than a FOV of the fifth camera.

8. The HMD of claim 1, wherein:
the first camera is disposed on a sensor bar of the HMD, and the second camera is disposed on the sensor bar,
the first camera is disposed at a first position on the sensor bar, the first position being above a first eye of a user of the HMD, and
the second camera is disposed at a second position on the sensor bar, the second position being above a second eye of the user.

9. The HMD of claim 1, wherein the first camera, the second camera, and the fifth camera are disposed in a first single row on a sensor bar of the HMD.

10. The HMD of claim 9, wherein the third camera, the fourth camera, and the sixth camera are disposed in a second single row on the sensor bar of the HMD.

11. The HMD of claim 1, wherein the first camera, the second camera, the third camera, the fourth camera, the fifth camera, and the sixth camera are all disposed in a same single row on a sensor bar of the HMD.

12. The HMD of claim 1, wherein the fifth camera is positioned an equal distance between the first camera and the second camera.

13. The HMD of claim 12, wherein the sixth camera is positioned an equal distance between the third camera and the fourth camera.

14. A system comprising:
a first camera of a first modality;
a second camera of the first modality, the first camera and the second camera forming a first stereoscopic pair of cameras;
a third camera of a second modality; and
a fourth camera of the second modality, the third camera and the fourth camera forming a second stereoscopic pair of cameras.

15. The system of claim 14, wherein the first stereoscopic pair of cameras are arranged in a first row, wherein the second stereoscopic pair of cameras are arranged in a second, different row that is either above or below the first row.

16. The system of claim 14, wherein the first stereoscopic pair of cameras and the second stereoscopic pair of cameras are all arranged on a same single row.

17. The system of claim 14, wherein the first camera, the second camera, the third camera, and the fourth camera have fields of view (FOVs) that are relatively larger than FOVs of a fifth camera and a sixth camera.

18. The system of claim 17, wherein the first camera, the second camera, the third camera, and the fourth camera have angular resolutions that are relatively smaller than angular resolutions of a fifth camera and a sixth camera.

19. A system comprising:
a first camera of a first modality;
a second camera of the first modality, the first camera and the second camera forming a pair of stereoscopic cameras; and
a different camera of the first modality;
wherein an angular resolution of the different camera is higher than angular resolutions of the pair of stereoscopic cameras, and
wherein a first separation distance between the first camera and the second camera is at least initially set to an average interpupillary distance (IPD) of an adult user of the system.

20. The system of claim 19, wherein focal planes of the first and second cameras are set to a near distance and a focal plane of the different camera is set to a far distance.
